(19) United States
(12) Patent Application Publication
(10) Pub. No.: US 2005/0049966 A1
(43) Pub. Date: Mar. 3, 2005

(54) Ensuring the accurateness and currentness of information provided by the submitter of an electronic invoice throughout the life of a matter using tentative electronic invoice submission

(75) Inventors: Thomas G. Melling, Sammamish, WA (US); Ronald Wencel, Frankfort, IL (US); Greg Shriber, Issaquah, WA (US); Richard Boone, Kirkland, WA (US); Donald Murray, Bellevue, WA (US); Robert Thomas, Mercer Island, WA (US)

Correspondence Address: PERKINS COIE LLP;PATENT-SEA, P.O. BOX 1247, SEATTLE, WA, 98111-1247, US

(73) Assignee: Legal Systems Holding Company, Bellevue, WA (US)

(21) Appl. No.: 10/923,606

(22) Filed: Aug. 20, 2004

Related U.S. Application Data
(63) Continuation-in-part of application No. 10/864,290, filed on Jun. 9, 2004.
(60) Provisional application No. 60/477,425, filed on Jun. 9, 2003.
(60) Provisional application No. 60/497,247, filed on Aug. 22, 2003.
(60) Provisional application No. 60/497,246, filed on Aug. 22, 2003.

(51) Int. Cl. G06F 17/60

(52) U.S. Cl. 705/39

(57) ABSTRACT

A facility for collecting specified information in conjunction with the submission of an invoice by submitter is described. The facility provides a mechanism usable by the submitter to provide the specified information. When the facility receives the invoice from the submitter, the facility makes the invoice available for payment only after the mechanism has been used by the submitter to provide the specified information.

### CROSS-REFERENCE TO RELATED APPLICATION(S)

This application claims the benefit of U.S. Provisional Patent Application No. 60/497,247 filed on Aug. 22, 2003; U.S. Provisional Patent Application No. 60/497,246 filed on Aug. 22, 2003; U.S. patent application Ser. No. 10/864,290 filed on Jun. 9, 2004, each of which is hereby incorporated by reference in its entirety.

This application is a continuation-in-part of U.S. patent application Ser. No. 10/864,290 filed on Jun. 9, 2004, which is hereby incorporated by reference in its entirety.

This application is related to U.S. Provisional Patent Application No. 60/477,425 filed on Jun. 9, 2003, which is hereby incorporated by reference in its entirety.

### TECHNICAL FIELD

The present invention is directed to the field of automated tools for managing vendors, such as law firms.

### BACKGROUND

Corporate law departments and claims departments of insurance companies (collectively, “companies” or “clients”) have used matter management systems to track information about legal matters and projects (collectively, “matters”). One of the major weaknesses of these systems is that the information stored in these systems can be initially inaccurate, partially incomplete, and/or not kept updated and current. Unless the important matter data for a company's matters is accurate and kept current, reports based on this matter data are unreliable.

There are many reasons why the data is not accurately provided or kept current during the life of a matter. One reason is that although the data about the matter already exists, it has to be reentered into the system. For example, if a law firm manages a matter for a company, the law firm will have information about the current status of the matter. If the law firm does not have access to a company's matter management system, however, the law firm must first send a status report to the company in the mail or via electronic mail, and then the company has to reenter the data into the company's matter management system. Because of heavy workloads and the need to reduce expenses by minimizing employees, companies frequently never reenter the data into the matter management system, causing the system to have incomplete and missing data.

Second, some outside vendors may not appreciate the importance and detrimental consequences to a company if its matter management system does not have accurate and current data. Consequently, outside vendors (i) fail to provide data that the company has specifically requested to track in its matter management system and/or (ii) do not take the time to provide accurate data to the company and update such data when necessary. If a matter management system makes the outside vendor directly responsible for providing the data and provides feedback to the outside vendor responsible user about the accuracy of the information, or provides a method to prompt the outside vendor to review the information, the outside vendor responsible users are more likely to provide accurate information and keep such information current.

Third, if a company has not received data from an outside vendor managing a matter that the company would like to maintain in the company's matter management system, many companies do not have the time or willingness to repeatedly follow up with the firm to provide such data. For example, some companies desire that the law firm representing the company in a litigated matter provide a detailed case analysis and assessment 30-60 days after the case has been initiated. Informal surveys of such companies, however, reveal that in many situations the company never receives such an assessment from its law firm handling the case.

Fourth, many matter management systems have a set of fields that must be completed to create a matter on the system, but some types of data are not immediately available, and may not be known or reasonably provided until weeks or even months after the matter has commenced. An example of this type of information includes an estimate of exposure in a litigated matter, because the person providing the information has not had a reasonable opportunity to investigate the facts or the law affecting the litigation. Consequently, if a single form is used to input all of the information about a matter at the inception of the matter, users will frequently put in inaccurate or “dummy” information with respect to information that cannot be reasonably known or provided until weeks or months later. If a user forgets to update the inaccurate or “dummy” data, and the system does not prompt the user to review and/or update the data, the data will never be corrected in the system.

Finally, some of the information about the matter may change during the life of the matter. Frequently, however, users will forget or fail to update such information, and therefore the information does not remain current and accurate.

A system may try to overcome some or all of the aforementioned shortcomings relating to the accurateness and currentness of information in a matter management system by conditioning the outside vendor's ability to submit an invoice on the currentness of the information for which the outside vendor is responsible. For example, such a system may notify the outside vendor that certain required information with respect to a matter or group of matters is due or must be updated, and not allow the outside vendor to submit an invoice to the matter or a group of matters if the information has not been provided or updated. Thus, even though the invoice submission process and the information for which the outside vendor is responsible are unrelated, the system uses the invoicing process (in other words, the strong desire of the outside vendor to be paid) as leverage to ensure that the outside vendor has provided information for which it is responsible. Such a system, including all permutations described in the U.S. patent application Ser. No. 10/864,290 filed on Jun. 9, 2004, are collectively referred to herein as a “Data Current Invoice Blocking System.”

Use of a Data Current Invoice Blocking System can create problems, however. First, because the required information contemplated by the Data Current Invoice Blocking System is unrelated to the invoice, the user attempting to submit the invoice on behalf of the outside vendor (the “Invoice Submitter”) may not know or have readily-available access to such information. In addition, the Invoice Submitter may not have the ability or authority to provide such information in the Data Current Invoice Blocking System. For example, the information might be highly confidential, and therefore only an attorney subject to the attorney-client privilege doctrine should provide the information in the Data Current Invoice Blocking System. Consequently the Invoice Submitter cannot complete his or her job, which is to deliver the invoice to the client (in this case electronically). This forces the Invoice Submitter to contact the outside vendor user who is responsible for the required information, and wait until the required information has been completed. In other words, the task of submitting an electronic invoice is not within the full control of the user attempting to submit the invoice, and such user must rely on others to be able to complete his or her responsibility of submitting an invoice.

A second problem is that a client might want to require certain information depending on the nature of the information contained submitted invoice. For example, if the invoice exceeds the budget for the invoicing period, the client might wish to have the outside vendor provide an explanation why the invoice is over the budget. The Data Current Invoice Blocking System does not have the ability to require information that is conditional upon the combination of certain matter-related information and information in the invoice, because the check for the required information occurs at the time that the invoice is submitted, rather than after the invoice is submitted.

Accordingly, a software facility that overcame some or all of the aforementioned shortcomings relating to the ability of a system to leverage the process of invoice submission to the completion of required information without affecting the ability of an Invoice Submitter to complete his or her task of submitting electronic invoices would have significant utility to corporate law departments, claims departments of insurance companies, other companies managing projects, and outside vendors such as law firms who submit invoices.

### BRIEF DESCRIPTION OF THE DRAWINGS

FIG. 1 is a high-level block diagram showing a typical environment in which the facility operates.

FIGS. 2A & 2B are display diagrams showing a typical user interface for entering the types of administrative information that may be required of an outside vendor, such as matter information, budget information, status report information, and/or spending accrual information, and when such information will be required.

FIG. 3 is a display diagram showing a setup of a new matter in which a user specifies outside vendor responsible for the matter, and if allowed by the system level setup, which budget information, status report information, and/or spending accrual information is required of the outside vendor.

FIG. 4 is a display diagram showing sample alerts to the responsible user (and his or her delegates) of the outside vendor regarding what information is due and that must be provided before an invoice can be processed.

FIG. 5 is a sample table diagram showing how the facility determines what matter data fields are required to be completed by the outside vendor.

FIG. 6 is a flow diagram showing steps typically performed by the facility to determine the matter data fields that are required to be completed by the outside vendor.

FIG. 7 is a display diagram showing a typical web page form presented to the responsible user (and his or her delegates) of the outside vendor so that such user can provide the required matter data.

FIG. 8 is a sample table diagram showing how the facility determines whether the outside vendor is responsible for providing a budget, when the budget is due, and what type of budget must be provided.

FIG. 9 is a flow diagram showing steps typically performed by the facility to determine whether the outside vendor is responsible for providing a budget, when the budget is due, and what type of budget must be provided.

FIG. 10 is a display diagram showing the web page form that might be presented to the responsible user (and his or her delegates) of the outside vendor so that such user can provide the required budget information.

FIG. 11 is a table diagram showing how the facility determines if and when a status report is due and what fields are required to be completed by the outside vendor in the status report.

FIG. 12 is a flow diagram showing steps typically performed by the facility to determine when a status report form is due and what data is required to be completed by the outside vendor in the status report form.

FIG. 13 is a display diagram showing the web page form that might be presented to the responsible user (and his or her delegates) of the outside vendor so that such user can provide the required status report data.

FIG. 14A is a flow diagram showing steps associated with the submission of an electronic invoice, and how the facility determines if a submitted invoice will allowed to be processed (i.e., whether there is required information that is due at the time the outside vendor submits an invoice).

FIG. 14B is a flow diagram showing examples of the checks the facility conducts to determine if information is due or other conditions have not been satisfied, in which case the facility will not allow the invoice to be processed.

FIG. 15A is a table diagram showing how the facility could distinguish invoices that have been submitted but may not be processed because required information is due by maintaining such invoices in a separate table from the table of invoices that have been submitted and are allowed to be processed.

FIG. 15B is an alternate table diagram showing how the facility distinguishes invoices that have been submitted but may not be processed because required information is due by creating a special field to “flag” those invoices that may not be processed until the required information is provided.

FIG. 16 is a display diagram showing an example of a web page form used by an outside vendor to submit an invoice.

FIG. 17 is a display diagram showing to the Invoice Submitter the invoice submission results and notifications regarding invoices that were successfully submitted but could not be processed because required information is due.

FIG. 18 a display diagram showing the outside vendor invoices that the outside vendor has submitted and the current status of the invoice (e.g., (i) any invoice that was submitted but cannot be processed because required information is due from the outside vendor; (ii) any invoice that was submitted and delivered to the client, and is being approved by the client; and (iii) any invoice that was submitted and delivered to the client, and has been approved, reduced, or rejected by the client).

FIG. 19 is a display diagram showing the responsible user of the outside vendor (and his or her delegates) (1) alerts regarding invoices that have been submitted but the facility will not allow to be processed and (2) what information is due and that must be provided before such a submitted invoice can be processed.

FIG. 20 is a flow diagram showing steps typically performed by the facility to determine whether an invoice may be processed after the outside vendor enters information into the system that may satisfy a currently pending requirement for information or other condition in a matter.

### DETAILED DESCRIPTION

A software facility (“the facility”) for ensuring the accurateness and currentness of information provided by the submitter of an electronic invoice throughout the life of a matter using tentative invoice submission (the “facility”) is described. In some embodiments, the facility is operated on a network such as the Internet in which both client users (such as corporate law department users or insurance claims department users) and outside vendors (such as law firms, consulting firms, or other submitters of invoices) can access the facility. Outside vendors are made responsible for using the facility to input matter information that is directly relevant to their work on the matter. For example, outside vendor law firm users are responsible for (a) filling out information about the matter such as relevant country and state, (b) providing a document or information that characterizes the present status of the matter, referred to herein as a “status report,” and (c) providing a budget for the matter. In other words, by operating the matter management facility on a shared network, the facility captures information at the most logical source by requiring the outside vendors to enter their information into the facility rather than sending the information to the company users and requiring the company users to reenter the information into the facility.

In some embodiments, the facility uses dynamic forms to require that users review or update data temporally. The facility is configurable so that the company can specify when during the life of the matter certain information is required to be provided by the outside vendor. This configurability could be at the facility-level, across all of a company's matters, and/or on a matter-by-matter basis. In some embodiments, the facility notifies the outside vendor that certain required information is due or must be confirmed to be accurate.

The facility (i) enables the outside vendor user to submit an invoice into the facility with respect to a matter, (ii) then checks for information required or other conditions in the matter by the client's facility-level or matter-level configuration, and (iii) permits the invoice to be “processed” by the client only after the required information for the matter is entered or other matter conditions have been satisfied. An invoice is submitted when it is transferred from the outside vendor to the facility for eventual transfer to the client. An invoice is processed when the client (A) reviews and approves the invoice and (B) actually pays the invoice. If any required information has not been completed with respect to the matter to which the invoice has been submitted, the facility prohibits the processing of the invoice. Such prohibition may involve, for example: not delivering nor making visible the invoice to client users, not allowing client users to review and approve the invoice, or not allowing the approved amount of the invoice to be paid (either by (i) prohibiting the facility from making the payment, (ii) not allowing the facility to send the approved invoice information to the client's accounts payable department or system, or (iii) not allowing the client's accounts payable department or system to pay the invoice). In some embodiments, if the invoice has been submitted but is not permitted to be processed, the facility notifies the outside vendor that certain required information is due or must be updated before the submitted invoice may be processed.

Embodiments of the facility provide several benefits. The facility ensures the accurateness and currentness of information provided by the submitter of an electronic invoice throughout the life of a matter by forcing the submitter of an electronic invoice provide certain information specified by the client before the invoice can be processed. The facility, however, also enables an individual user who is responsible for preparing and delivering invoices for an outside vendor (i.e., the Invoice Submitter) to complete his or her job by allowing such Invoice Submitter to submit an invoice into the facility. This also creates the benefit of segmenting responsibilities to the appropriate user of the facility. In other words, the design of this facility segments the responsibilities of Invoice Submitters from the responsibilities of other outside vendor users who are responsible for providing matter-related or other specified information in the facility.

Finally, the facility enables the client to specify rules of required information that combines information that is separate from the invoice (e.g., a budget for a matter) with information contained within the invoice (e.g., the actual amount of the invoice). In other words, if the facility did not have the capability of tentative invoice submission, it could only generate rules for required information that exist wholly independent of the invoice, instead of rules that combine other information with the information in the invoice. For example, if an invoice is submitted in which the total spending for a certain time period including the invoice is greater than the budget for the time period (e.g., the service period of the invoice, fiscal year-to-date, cumulative life of the matter, or any other time period), certain embodiments of the facility could allow the invoice to be posted but not processed until the vendor has provided an explanation as to why the spending (including the amount of the invoice) is greater than the budgeted amount.

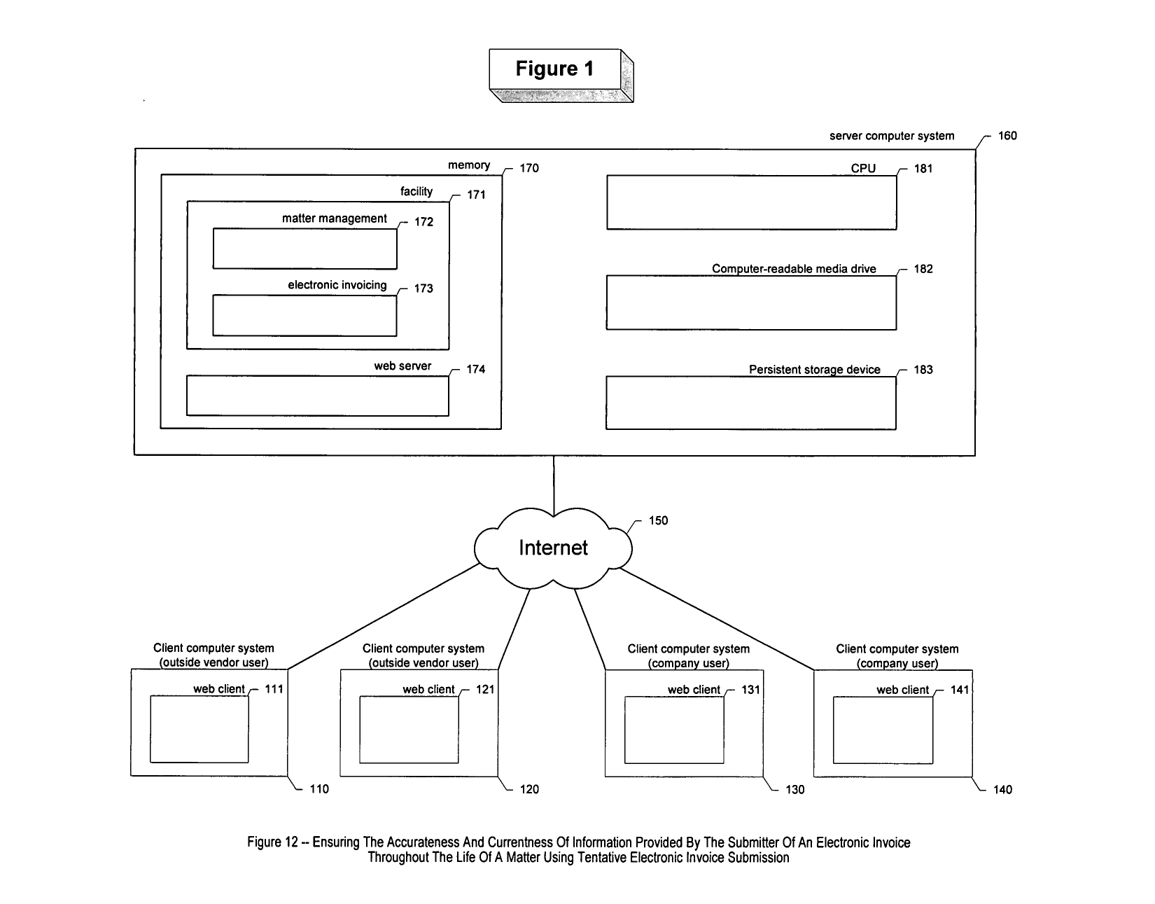

Details of how the facility may be implemented are described below in conjunction with FIGS. 1-20.

FIG. 1 is a high-level block diagram showing a typical environment in which the facility operates. The block diagram shows several client computer systems (which are company users and outside vendor users), such as client computer systems 110, 120, 130, and 140. Each of the client computer systems has a web client computer program for browsing the World Wide Web, such as web clients 111, 121, 131, and 141. The client computer systems are connected via the Internet 150 to a server computer system 160 hosting the facility. Those skilled in the art will recognize that client computer systems could be connected to the server computer system by networks other than the Internet, however. To be able to connect to the server computer system, the client computer systems must properly authenticate itself to the server computer system, such as by providing user ID and password, or using other authentication technology.

The server computer system 160 contains a memory 170. The memory 170 preferably contains the facility 171, incorporating both matter management functionality 172 and electronic invoicing functionality 173 typically used by the facility. The memory preferably further contains a web server computer program for delivering web pages in response to requests from web clients. While items 171-174 are preferably stored in memory while being used, those skilled in the art will appreciate that these items, or portions of them, may be transferred between memory and a persistent storage device 183 for purposes of performing memory management and maintaining data integrity. The server computer system further contains one or more central processing units (CPU) 181 for executing programs, such as programs 171-174, and a computer-readable media drive 182 for reading information or installing programs such as the facility from computer-readable media, such as a floppy disk, a CD-ROM, or a DVD.

While various embodiments are described in terms of the environment described above, those skilled in the art will appreciate that the facility may be implemented in a variety of other environments including a single, monolithic computer system, as well as various other combinations of computer systems or similar devices connected in various ways. Additionally, those skilled in the art will appreciate that the facility may be implemented using various software configurations, such as configurations in which the matter management and electronic invoicing software are merged, or other configurations in which their functionality is divided across a larger number of modules, and/or distributed over multiple computer systems.

FIGS. 2A & 2B are display diagrams showing a typical user interface for entering the types of administrative information that may be required of an outside vendor, such as matter information, budget information, status report information, and/or spending accrual information, and when such information will be required. This “setup” user interface, shown on web page 200, is therein titled “Customize Matter—Litigation/Arbitration—Employment Discrimination.” As shown, the setup is organized into several categories of information, such as budget setup and required information 210, status report setup and required information 230, and matter field setup and required information 250.

In the budget setup section 210, the facility enables the company user to specify whether a budget is required of the outside vendor 213 and when the budget is required 214, what type of budget is required 212, and/or whether an accrual entry for outside vendor spending during the fiscal year that has not yet been billed (used by companies that use the “accrual” method of accounting) 215 and when the accrual entry is required 216.

In the status report setup section 230, the facility enables the company user to specify whether a monthly or quarterly status report is required of the outside vendor 232 and when the first status report is required 233; whether a detailed case assessment is required to be attached to a status report 234 and in which status report the detailed case assessment should be provided 235; whether a detailed trial analysis is required to be attached to a status report 236 and in which status report the detailed trial analysis should be provided 237; and/or whether the matter budget 238, estimates of exposure/recovery 239, and/or estimates of resolution are required, and if already provided displayed and confirmed 240, and when such data (i.e., 238-240) is first required to be provided/confirmed 241.

With respect to the setup of the required budget information and the status report information, in some embodiments the facility prevents these settings from being altered during the setup of the matter. Alternatively, these settings can be created as default settings that are alterable by the user creating a matter 211, 231.

In FIG. 2B in the matter setup section 250, the facility enables the company user to specify what fields the firm is required to provide to complete the setup of the matter. For example, for some fields, the company user may select whether the field will be used 251, whether the firm is responsible for editing the field 252, and whether the field is required 253.

While various embodiments are described in terms of the setup described above, those skilled in the art will appreciate that the facility may be implemented in a variety of other setup criteria and options. For example, the setup could be varied (i) for every matter classification in the facility (e.g., litigation, transactional, advice and counsel, permit/licensing matters are examples of different matter classifications) and (ii) for each subject matter type within each matter classification (e.g., environmental, employment/labor, securities, business contracts, etc. are examples of different subject matter types). In addition, the types of required information and the timing of the information could also be specified with respect to the outside vendor. For example, some information could be required of certain vendors, and other vendors would not need to provide such information. Such settings could be specified vendor-by-vendor, or by category of vendor. Also, the facility may have other configurations with respect to the types of information that is required and the timing of the required information.

FIG. 3 is a display diagram showing a typical new matter setup in which a user specifies outside vendor responsible for the matter, and if permitted by the system-level setup described in FIGS. 2A and 2B, which budget information, status report information, spending accrual information, and/or other information is required of the outside vendor. (In the Detailed Description of this patent, unless otherwise specified “required” data refers to data that must be provided before invoice processing is allowed to occur.) This display diagram assumes that the administrative setup options described in FIG. 2A allows a person creating the matter to change the selections.

The matter setup page may have other selections about the matter which do not involved required data 301. However, in the budget setup section 310, the facility enables the company user to specify whether a budget is required of the outside vendor 313 and when the budget is required 314, what type of budget is required 312, and/or whether an accrual entry for outside vendor spending during the fiscal year that has not yet been billed (used by companies that use the “accrual” method of accounting) 315 and when the accrual entry is required 316.

In the status report setup section 330, the facility enables the company user to specify whether a monthly or quarterly status report is required of the outside vendor 332 and when the first status report is required 333; whether a detailed case assessment is required to be attached to a status report 334 and in which status report the detailed case assessment should be provided 335; whether a detailed trial analysis is required to be attached to a status report 336 and in which status report the detailed trial analysis should be provided 337; and/or whether the matter budget 338, estimates of exposure/recovery 339, and/or estimates of resolution are required, and if already provided displayed and confirmed 340, and when such data (i.e., 338-340) is first required to be provided/confirmed 341.

In the Outside Vendor Responsible setup section 350, the facility enables the company user to specify the outside vendor user responsible for the matter 351 and the system automatically fills in the name of the outside vendor associated with such user 352. Those skilled in the art will appreciate that the user interface for selecting the outside vendor user responsible and the outside vendor may be implemented in a variety of other selection options. In addition, those skilled in the art will recognize that while the selections identified in FIG. 3 is on one web page, such selections may be made in a sequence of web pages.

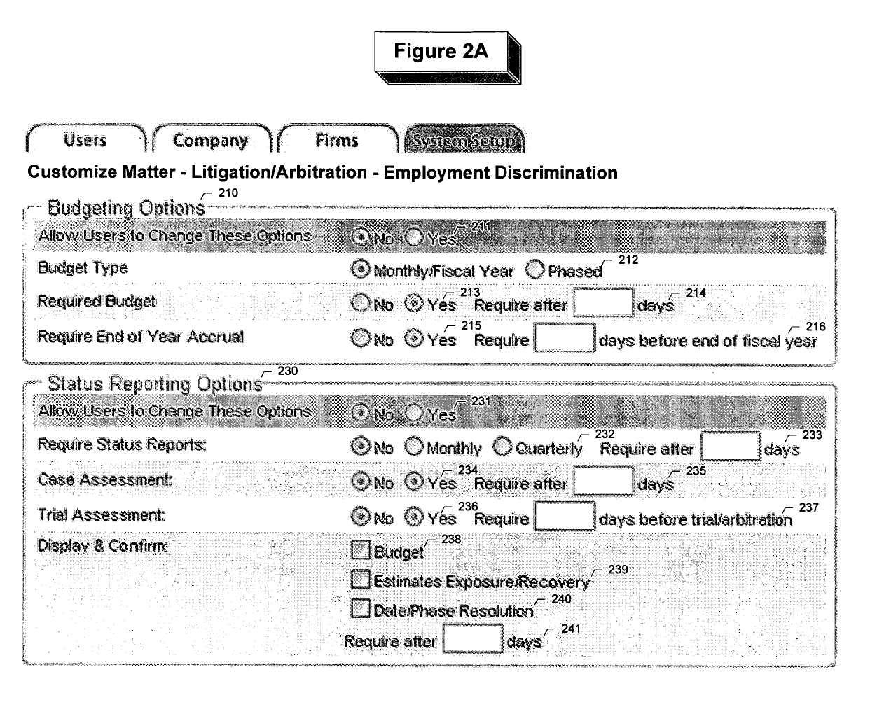

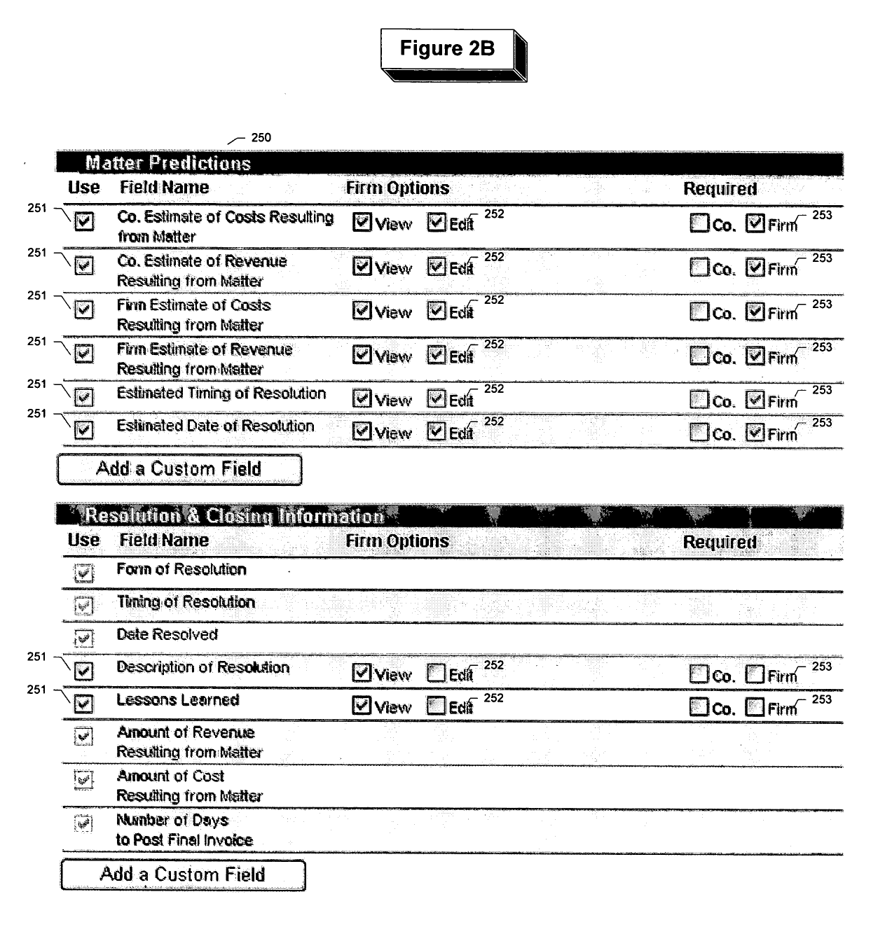

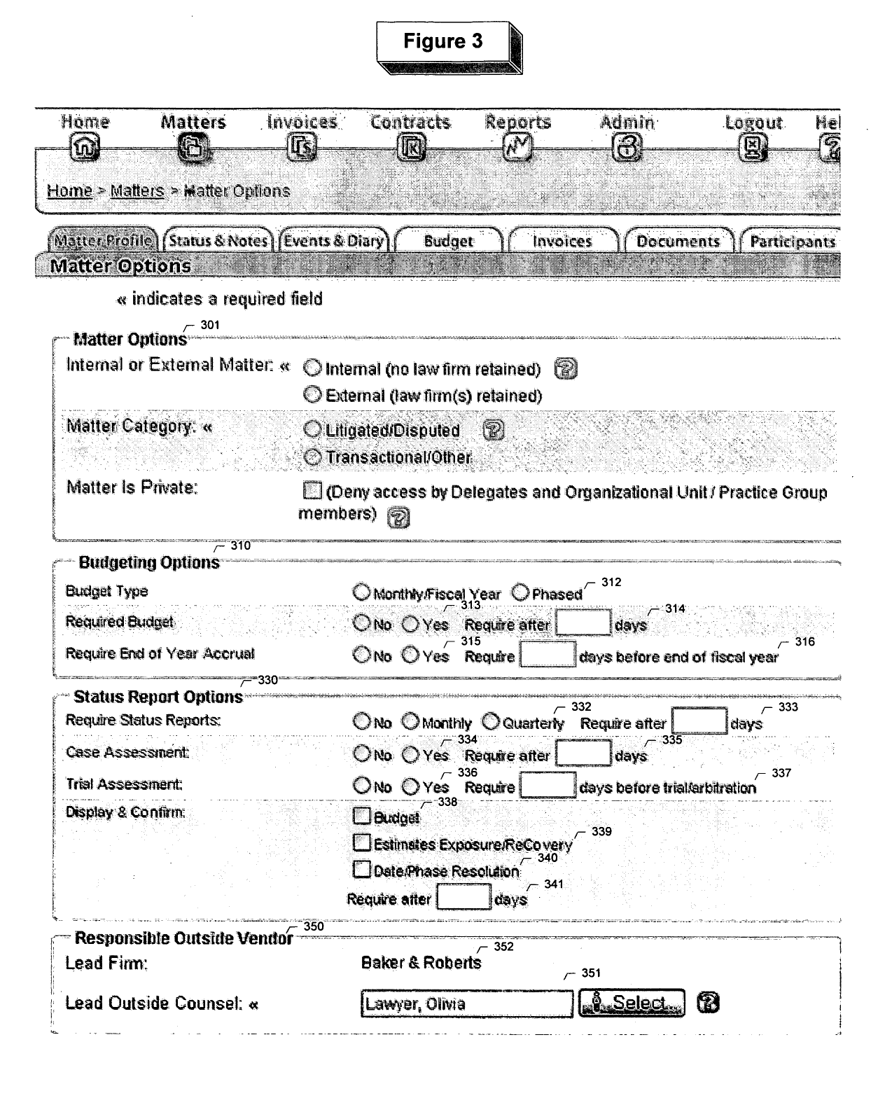

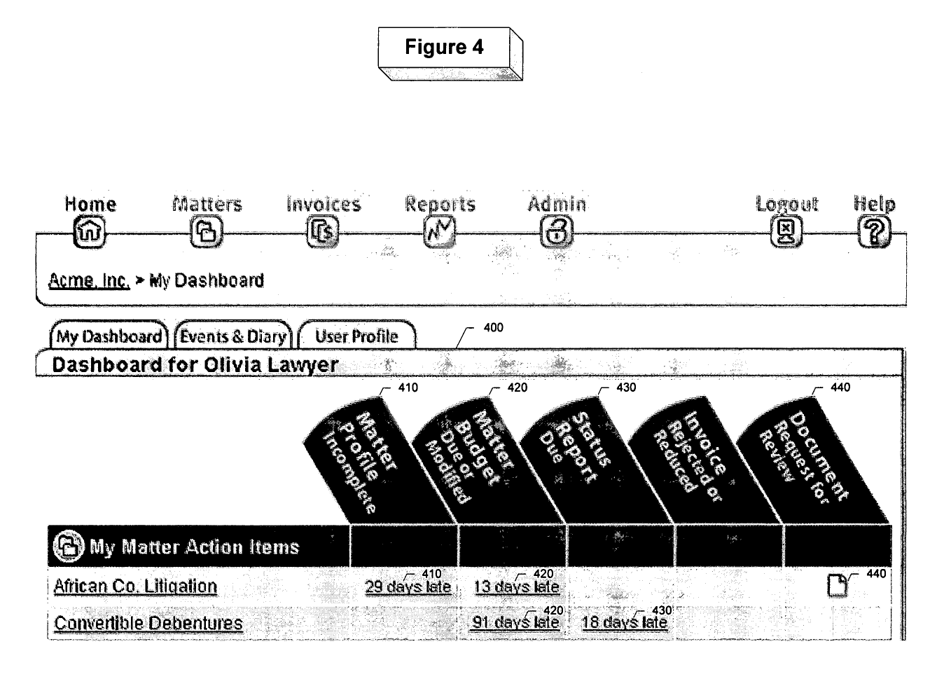

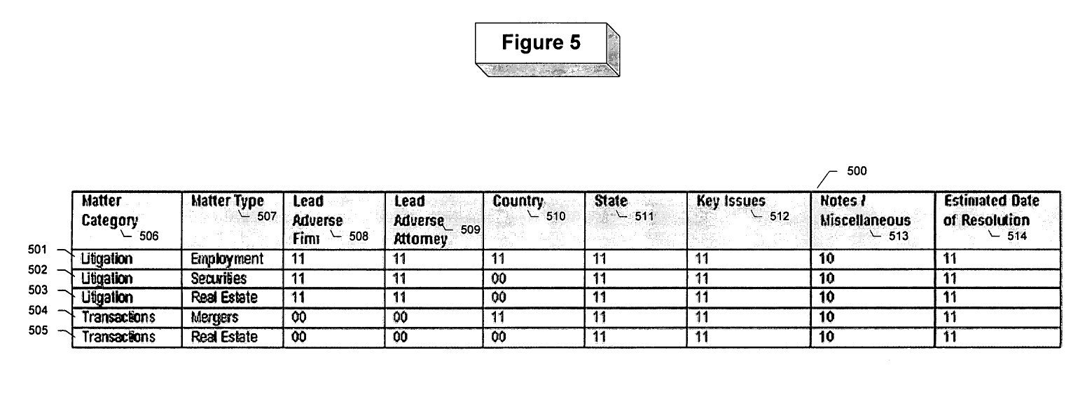

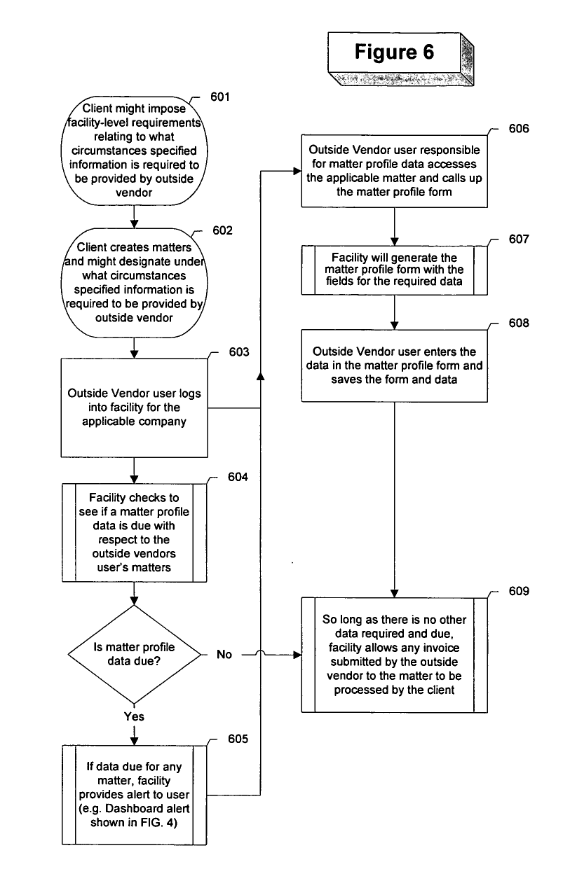

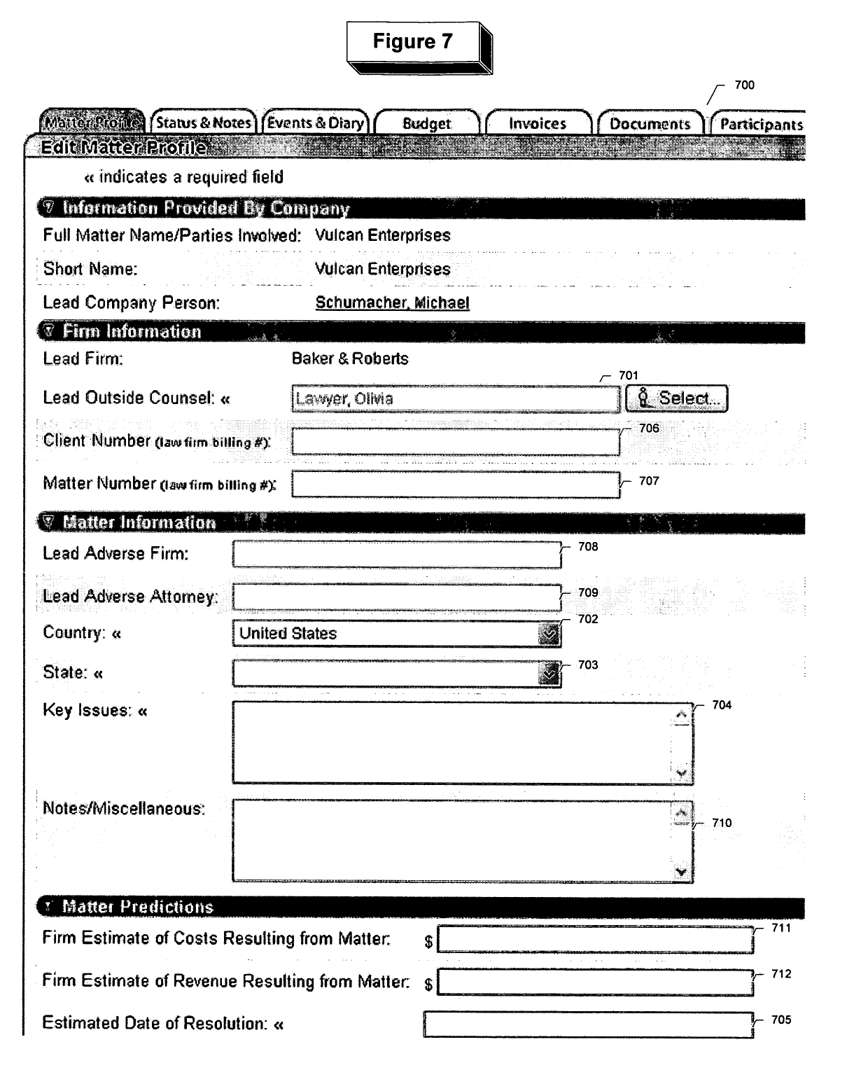

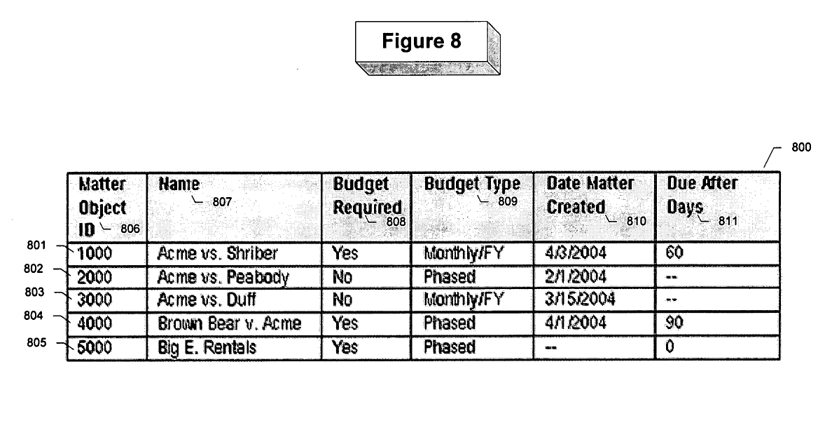

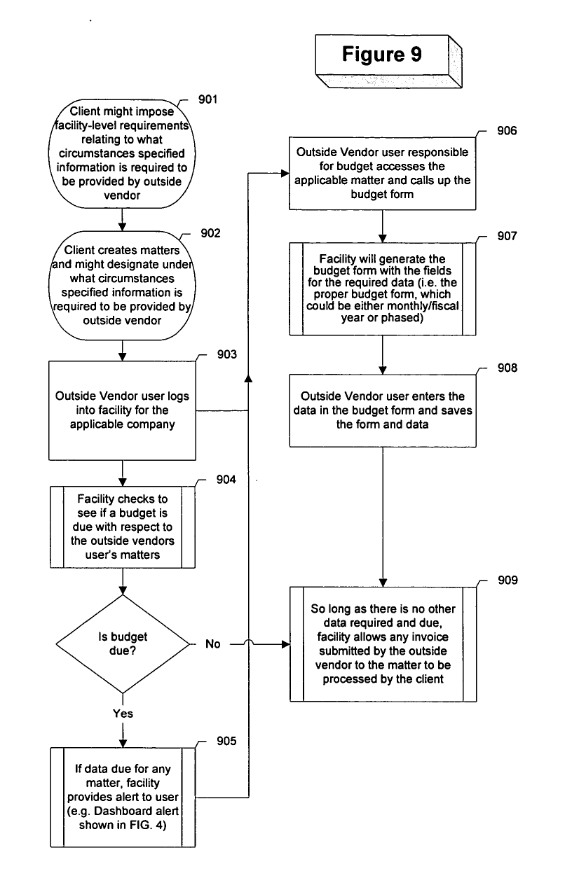

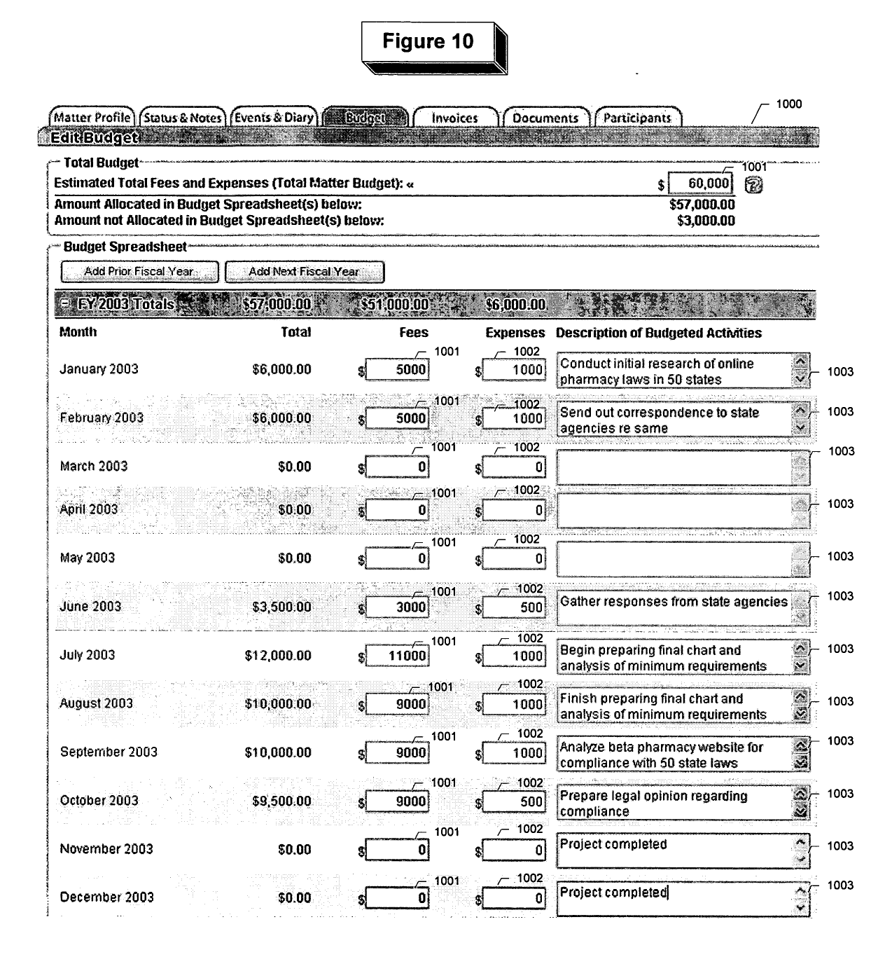

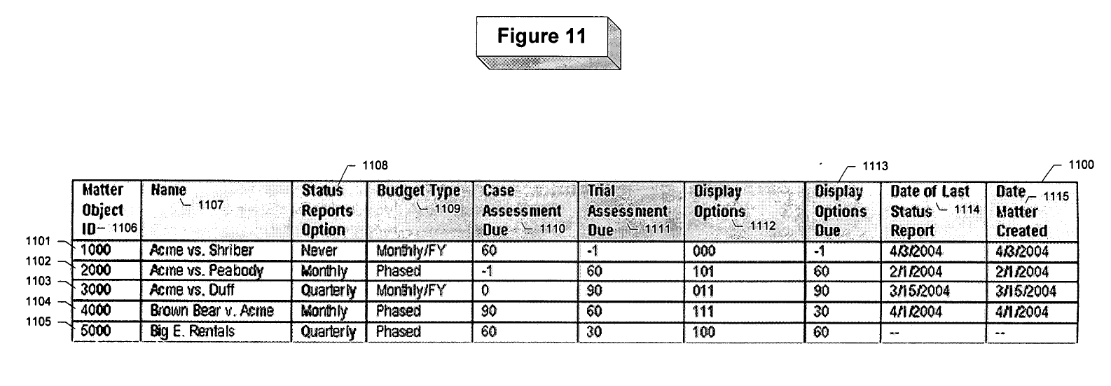

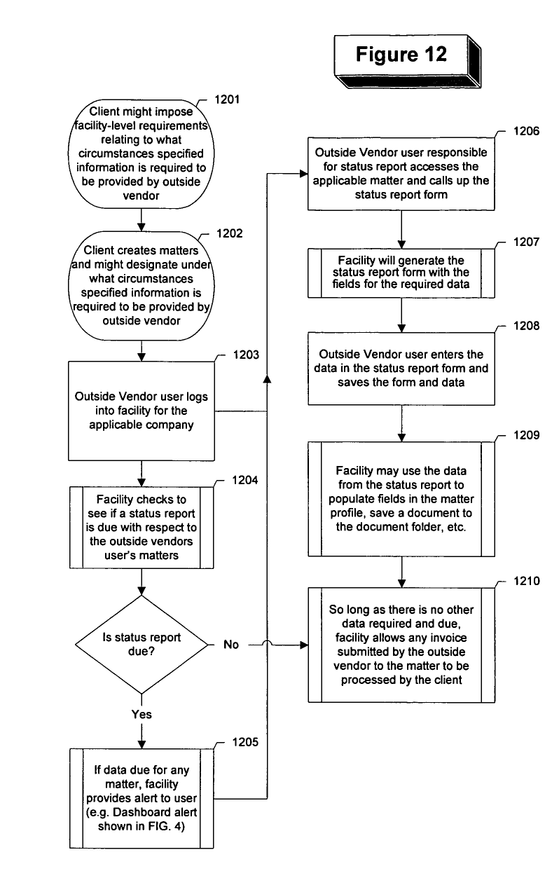

FIG. 4 is a display diagram showing sample alerts to the responsible user (and his or her delegates) of the outside vendor regarding what information is due and that must be provided before an invoice can be submitted. In this particular embodiment, the facility presents a web page 400 to the responsible person (and any delegates of the responsible person) each time he or she logs into the facility that shows a list of all of the required information that is due. For example, an alert may show if information is due for the matter 410, a budget is due 420, a status report is due 430, or a document is due or must be reviewed 440. In certain embodiments of the facility, the alert is a hyperlink, which the user can click on to display the form with the fields to provide the required information. Other embodiments not shown in FIG. 4 might contain an alert that accrual estimates are due. While various embodiments are described in terms of the alerts described above, those skilled in the art will appreciate that the facility may provide alerts for other required data or other of methods notifying the responsible person (and any delegates of the responsible person) that required information is due. For example, other embodiments of the facility may also send an email to the responsible person at the outside vendor (and to any delegates specified by the responsible person in his or her user profile) with a description of the required information that is due.

FIG. 5 is a sample table diagram showing how the facility determines what matter data fields are required to be completed by the outside vendor. The matter data table 500 is comprised of rows, such as rows 501-505, each of which corresponds to a unique matter classification. In the particular embodiment shown in FIG. 5, the unique matter classification is a combination of the matter category 506 and the matter type 507, but those skilled in the art will appreciate that the facility may be implemented using a variety of other matter classifications. In addition to the matter category 506 and the matter type 507 columns, each row is divided into columns containing the types of fields offered by the facility. In the particular embodiment illustrated in FIG. 5, the fields include Lead Adverse Firm 508; Lead Adverse Attorney 509; Country 510; State 511, Key Issues 512, Notes/Miscellaneous 513, and Estimated Date of Resolution 514. For each data field represented by a column, the facility determines (i) if the field is to be displayed to outside vendor users (if the first digit is a “1” the field is to be displayed, but if the first digit is a “0” the field is not to be displayed) and (ii) if the outside vendor is required to enter a value for the matter data field before an invoice submitted by the outside vendor to the matter may be processed (if the second digit is a “1” the field is required to be completed before invoices submitted by the outside vendor to the matter may be processed, but if the second digit is a “0” the field is not required).

While FIG. 5 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

FIG. 6 is a flow diagram showing steps typically performed by the facility to determine the matter data fields that are required to be completed by the outside vendor. The company first creates system-level requirements for data 601, or sets requirements for data when a matter is created 602. Then, after an outside vendor user responsible for data in one or more matters (or his or her delegates) logs into the facility 603, the facility checks to determine if the user is responsible for any matters in which data is required and due 604. This includes but is not limited to determining if matter data is due. If data is required and due for any of the user's matters, the facility provides an alert for each matter in which matter data is due (as shown in FIG. 4) 605. The user can access the matter and call up the matter data form for the matter 606, and the facility will generate the matter data form with the fields for the required data 607. The user can then enter the data in the matter data form, and save the form 608. Once the matter data has been provided that satisfies the requirement for the data that is required and due, the facility allows any invoice that the outside vendor has submitted to the matter to be processed so long as no other data is required and due for the matter 609.

Those skilled in the art will appreciate that the steps shown in FIG. 6 and in each of the flow diagrams discussed below may be altered in a variety of ways. For example, the order of the steps may be rearranged; substeps may be performed in parallel; shown steps may be omitted, or other steps may be included; etc.

FIG. 7 is a display diagram showing a web page form presented to the responsible user (and his or her delegates) of the outside vendor so that such user can provide the required matter data. After the company creates the matter in the facility, the outside vendor fills out a form 700 containing the required information about the matter. At the creation of the matter, the data input form contains only those fields that are required to be immediately completed by the outside vendor 701-705. The form might also include fields that are optional for the outside vendor to complete 706-712.

FIG. 8 is a sample table diagram showing how the facility determines whether the outside vendor is responsible for providing a budget, when the budget is due, and what type of budget must be provided. The budget table 800 is comprised of rows, such as rows 801-805, each corresponding to a matter. Each row is divided into a matter ID column (which is the object ID in the facility) 806; the matter name 807; a code indicating whether the budget is required to be completed by the outside vendor 808; if a budget is to be required, the budget type 809; the date the matter was created 810; and the number of days after the matter was created that the budget is due 811. The facility can determine from the data in each row whether a budget is required of outside counsel, when the budget is due, and what type of budget must be provided. For example, for matter object ID 1000, because the matter was created on Apr. 3, 2004, and a budget is due 60 days later, the budget will be due on Jun. 2, 2004. The type of budget due for matter object ID 1000 would be a monthly/fiscal year budget.

FIG. 9 is a flow diagram showing steps typically performed by the facility to determine whether the outside vendor is responsible for providing a budget, when the budget is due, and what type of budget must be provided. The company first creates system-level requirements for data 901, or sets requirements for data when a matter is created 902. Then, after an outside vendor user responsible for data in one or more matters (or his or her delegates) logs into the facility 903, the facility checks to determine if the user is responsible for any matters in which data is required and due 904. This includes but is not limited to determining if a budget is due, and if so, which type of budget is due. If data is required and due for any of the user's matters, the facility provides an alert for each matter in which a budget is due (as shown in FIG. 4) 905. The user can access the matter and call up the budget form for the matter 906, and the facility will generate the budget form with the fields for the required data (i.e., the proper budget form, which could be either monthly/fiscal year or phased) 907. The user can then enter the data in the budget form, and save the form 908. Once the budget has been provided that satisfies the requirement for the data that is required and due, the facility allows any invoice that the outside vendor has submitted to the matter to be processed so long as no other data is required and due for the matter 909.

FIG. 10 is a display diagram showing the web page form that might be presented to the responsible user (and his or her delegates) of the outside vendor so that such user can provide the required budget information. If a budget is required for a matter, the facility presents a budget input form 1000 which the outside vendor is required to complete. As shown, the budget input form is separate from the matter information input form; in some embodiments, they are part of the same form. As shown, the budget input form is separate from the status report form; in some embodiments, they are part of the same form. As shown, the outside vendor specifies the total budget for the life of the matter 1001, and the fees 1002 and expenses 1003 budgeted for each month of the current fiscal year, together with a description of the tasks for each month 1004. In other embodiments, the facility uses different budget forms, such as budget amounts for certain tasks or certain time periods.

FIG. 11 is a table diagram showing how the facility determines if and when a status report is due and what fields are required to be completed by the outside vendor in the status report. The status report table 1100 is comprised of rows, such as rows 1101-1105, each corresponding to a matter. Each row is divided into a matter ID column (which is the object ID in the facility) 1106; the matter name 1107; the status report option 1108; if a budget is to be confirmed or updated in the status report, the budget type 1109; requirement that the status report include a case assessment and when it is due in terms of the number of days after the matter was created 1110; requirement that the status report include a trial assessment and when it is due in terms of the number of days before the trial data 1111; requirements for other data 1112 and when such data is due 1113; the date of the last status report 1114; and the date the matter was created 1115. The facility can determine from the data in each row whether a status report is due at any given time and what fields should be displayed in the status report. For example, the status report options column 1108 is one check to determine if a status report is due that month. If the selection is “Quarterly,” and the current day is Apr. 2, 2004, and if a status report was not submitted Apr. 1, 2004, or Apr. 2, 2004 (as shown in the date of the last status report 1114), then the status report is due (in this particular embodiment the “Quarterly” selection uses the quarters of a calendar year, but those skilled in the art will appreciate that the frequency of the reporting option or the cycle dates can vary).

Even if a status report is not required because of the status report option field, there are other reasons that a status report may be due. For example, if as shown the “Big E. Rentals” matter was created on Jan. 15, 2004, and if a case assessment is due 60 days thereafter, a status report due alert (see FIG. 4) would be generated and displayed to the outside vendor user responsible for the data (or his or her delegate) on Mar. 15, 2004, and the outside vendor would not be able to submit invoices until such status report data is provided. If an outside vendor opened up the status report form between March 15th and March 31, the form might include a field for the current status of the matter and a field in which the user is required to attach a document containing the case assessment prior to saving the form. If the user does not submit a status report during such time period, and opens up the status form report after March 31, the form may also require additional data (e.g., if the status report table specifies that a budget must be confirmed Quarterly).

Similarly, the facility can use the trial assessment due column 1111 to determine if a status report is due, and if the status report form should include an attachment containing the trial assessment (the facility must reference the trial date contained in a separate table in the facility, which can be cross referenced using the Matter Object ID 1106).

Similarly, the facility can use the “Display Options” column 1112 to determine (i) if the status report form displays the current budget (see FIG. 2A 238) and requires the outside vendor user to confirm or update the budget (if the first number in the three-digit sequence is a 1 the budget must be displayed and confirmed, if the digit is a 0, the budget is not displayed); (ii) if the status report form displays the current estimates of exposure/recovery (see FIG. 2A 239) and requires the outside vendor user to confirm or update the estimates of exposure/recovery (if the second number in the three-digit sequence is a 1 the estimates of exposure/recovery must be displayed and confirmed, if the digit is a 0, the estimates of exposure/recovery are not displayed); and/or (iii) if the status report form displays the resolution estimates (see FIG. 2A 240) and requires the outside vendor user to confirm or update the resolution estimates (if the first number in the three-digit sequence is a 1 the resolution estimates must be displayed and confirmed, if the digit is a 0, the resolution estimates are not displayed). In connection with the Display Option column, the facility uses the “Display Options Due” column 1113 to determine in what status report such data is shown and required to be updated (after which it will be included in all future monthly or quarterly status reports).

Those skilled in the art will recognize that the facility could be designed so that any type of data could be required to be input or updated in the status report form. Essentially, the status reporting tool can be used to ensure that any type of data in the facility is provided at a specific point in time, or periodically confirmed and/or updated throughout the life of the matter.

FIG. 12 is a flow diagram showing steps typically performed by the facility to determine when a status report form is due and what data is required to be completed by the outside vendor in the status report form. The company first creates system-level requirements for data 1201, or sets requirements for data when a matter is created 1202. Then, after an outside vendor user responsible for data in one or more matters (or his or her delegates) logs into the facility 1203, the facility checks to determine if the user is responsible for any matters in which data is required and due 1204. This includes but is not limited to determining if there is a monthly or quarterly status report due for the month, or if other data is required to be provided for that month such as a case assessment. If data is required and due for any of the user's matters, the facility provides an alert for each matter in which a status report is due (as shown in FIG. 4) 1205. The user can access the matter and call up the status report form for the matter 1206, and the facility will generate the status report form with the fields for the required data 1207. The user can then enter the data in the status report form, and save the form 1208. The facility will save and display the status report, and may save data to other portions of the facility (e.g., if the status report form included a case assessment document that was attached, the attached document will be saved in the documents folder for the matter; or if the data includes an estimated resolution date, the data will be saved in the matter profile for the matter) 1209. Once the status report has been provided that satisfies the requirement for the data that is required and due, the facility allows any invoice that the outside vendor has submitted to the matter to be processed so long as no other data is required and due for the matter 1210.

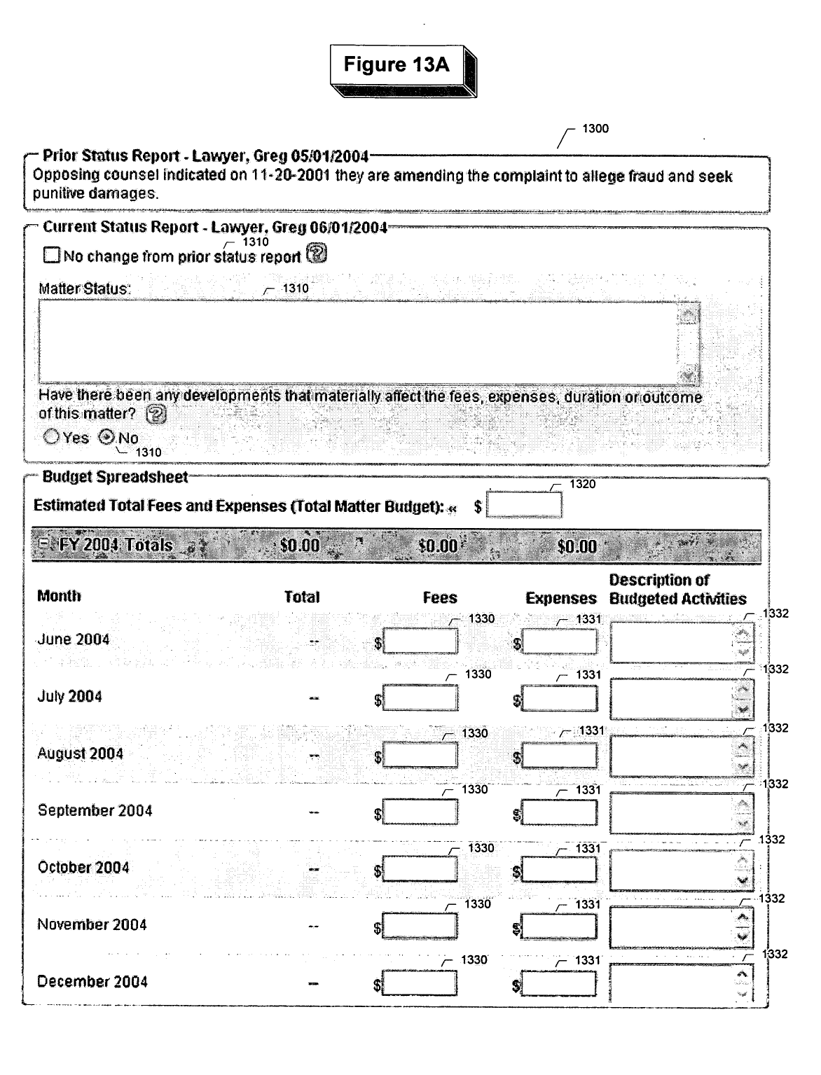

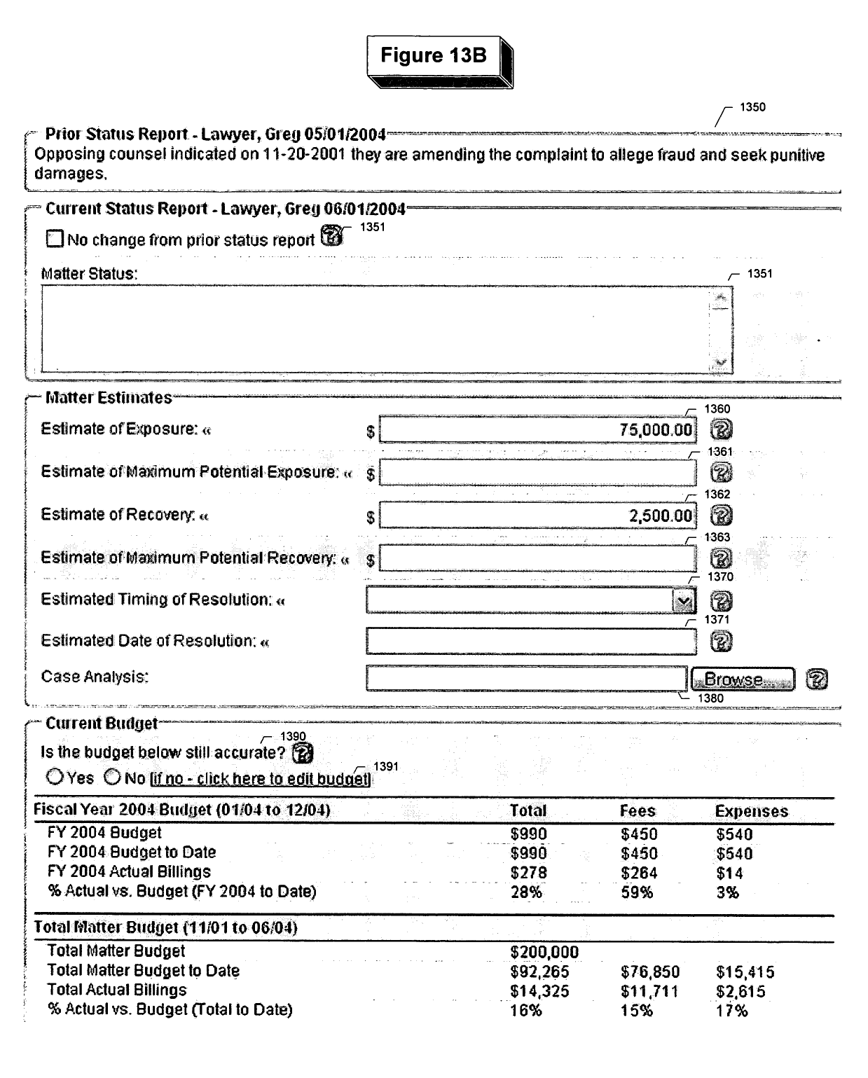

FIGS. 13A & 13B are display diagrams showing examples of web page forms that might be presented to the responsible user (and his or her delegates) of the outside vendor so that such user can provide the required status report data. FIG. 13A shows an example of the first status report input form 1300 for the matter that might be presented to the responsible user of the outside counsel. The form has a field to specify the current status 1310, a field to specify the total budget for the matter 1320, and fields to enter the monthly fees 1330 and expenses 1331 for each month of the current fiscal year, together with a field to enter a description of the activities for the applicable month 1332. FIG. 13B shows an example of the 3^{rd} month status report input form 1350 for the same matter that might be presented to the responsible user of the outside counsel. In this example, the form has a field to specify the current status 1351, fields to specify the estimates of exposure and recovery for the matter 1360-1363, fields to specify the estimated resolution of the matter 1370, 1371, a field to attach a file (such as a Microsoft Word document) that contains a case analysis for the matter 1380, and the budget displayed with a selection to confirm the budget 1390 or a link to update and correct the budget 1391. In other words, the data object which is in the form of a status report can change for each status report to display the required information that must be completed or updated at the time the status report is submitted. While various embodiments of a status report form are described above, those skilled in the art will appreciate that the facility may provide other fields for data in the status report form.

While FIGS. 5-13B describe how the facility may be set up to require information relating to matter information, budgets, and status reports, other embodiments of the facility may require other types of information be provided by the outside vendor in a similar manner. For example, the facility may provide companies the ability to require spending accrual information monthly, quarterly, and/or for the end of each fiscal year, and when such spending accrual information becomes due. Similar to required matter information, budgets, and status reports, the facility would provide a form to allow the outside vendor to enter such spending accrual information, and would not allow any invoice that the outside vendor has submitted to the matter to be processed if the spending accrual information is due for a specific matter but has not been provided by the outside vendor (or some facilities may require the spending accrual information be provided for all matters of the outside vendor before the outside vendor may submit an invoice to any matter).

Another example relates to approved timekeepers for the outside vendor for the matter. The facility may provide companies the ability to require the outside vendor to submit a list of timekeepers to a matter. The facility could either require the company to approve the timekeepers before the invoice may be processed, or could require the timekeepers to be approved or rejected as part of the processing of the invoice.

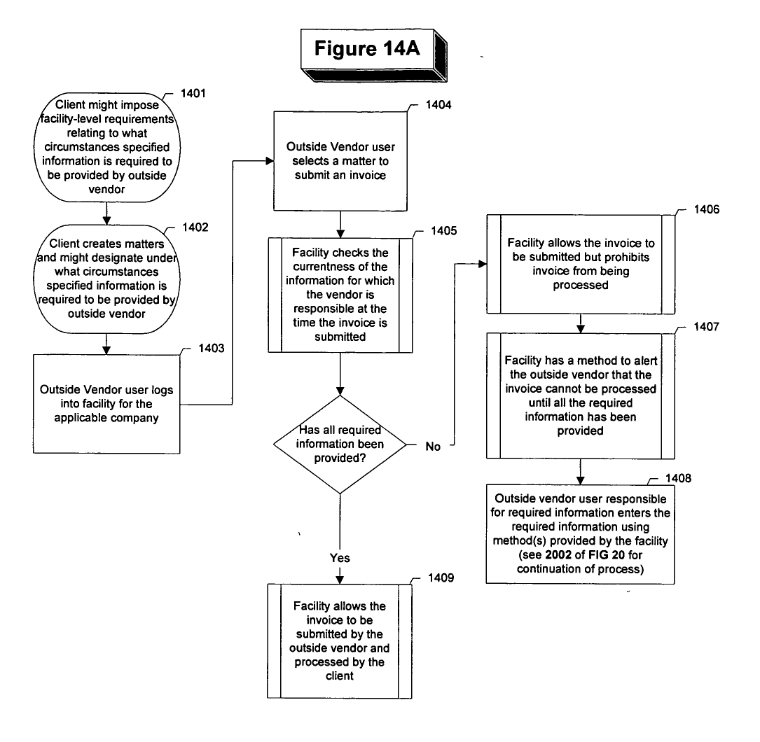

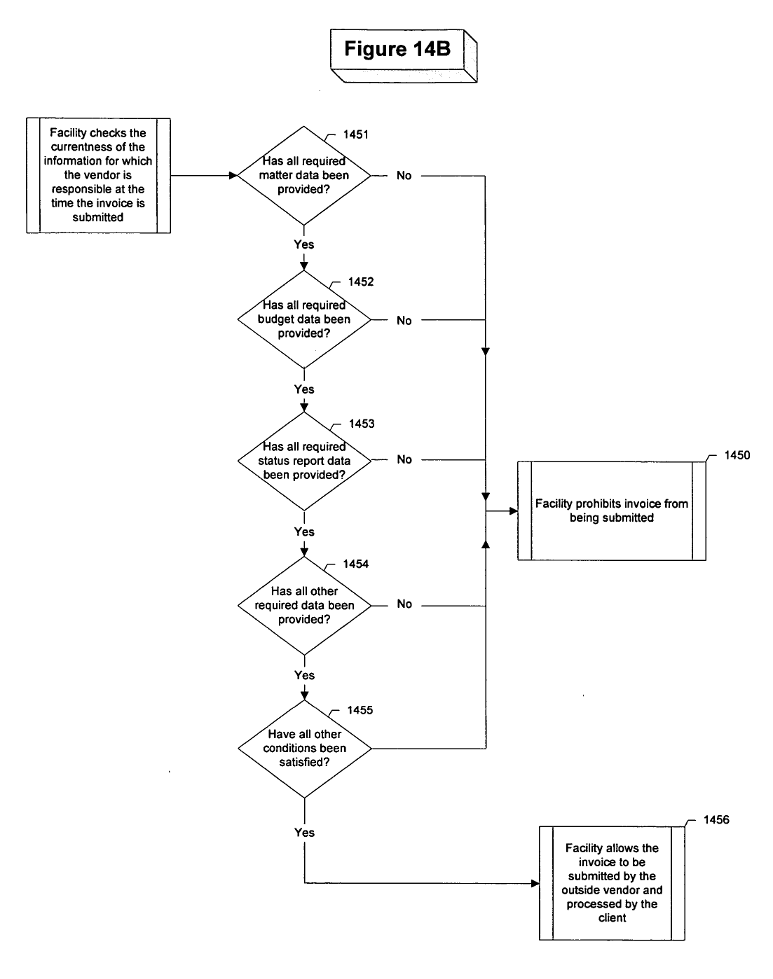

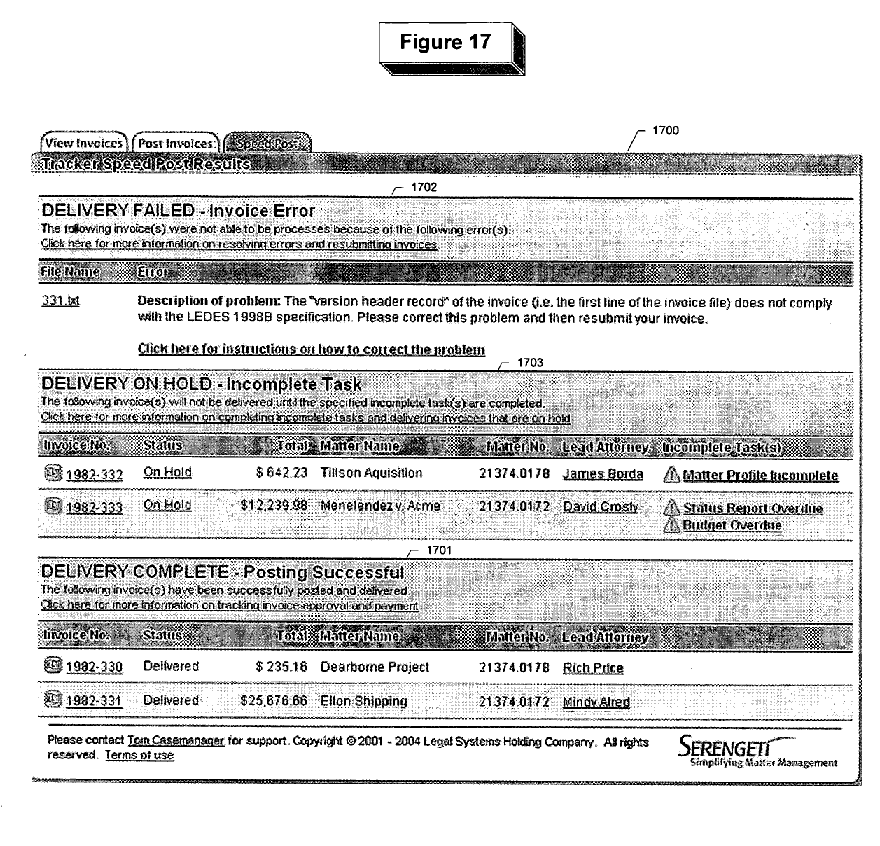

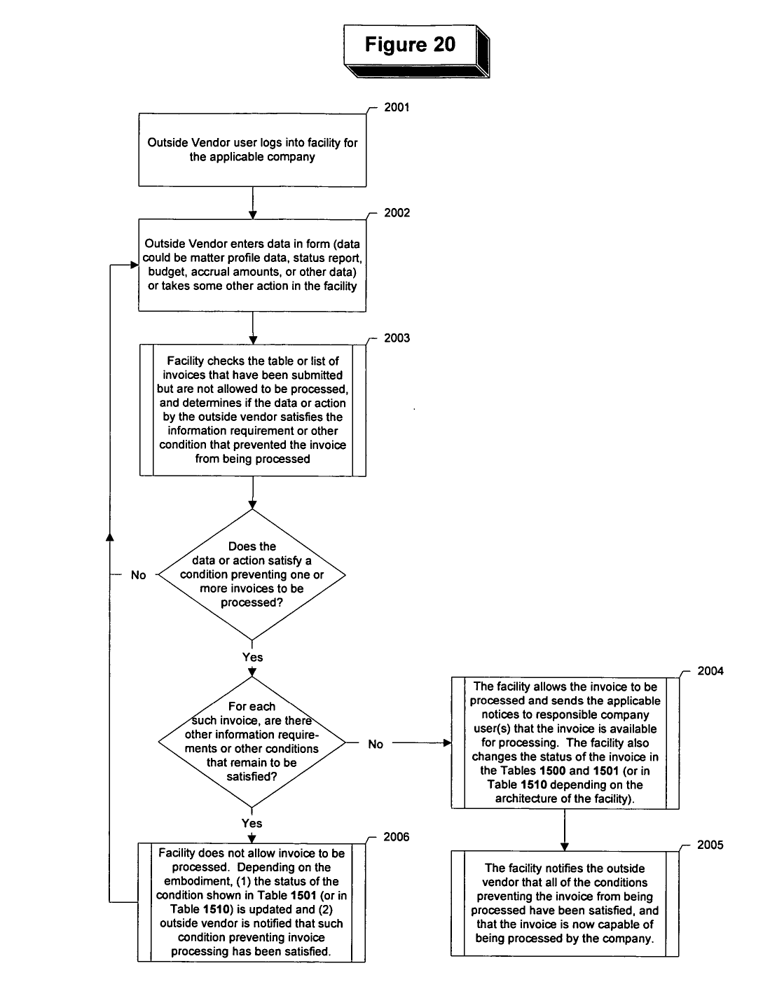

FIG. 14A is a flow diagram showing steps associated with the submission of an electronic invoice, and how the facility determines if a submitted invoice will allowed to be processed (i.e., whether there is required information that is due at the time the outside vendor submits an invoice). The company first creates system-level requirements for data 1401, or sets requirements for data when a matter is created 1402. When an outside vendor user logs into the facility 1403, the user can submit an invoice to a matter that has been created for the outside vendor 1404. When the invoice is submitted, the facility performs a check of the currentness of the information for which the vendor is responsible, and is required at the time of the submission of the invoice 1405. If the required information has not been provided, the facility will allow the invoice to be submitted, but will not allow the invoice to be processed 1406. In some embodiments, the facility will provide one or more notifications to the outside vendor that an invoice has been submitted but will not be processed until required information has been provided or other conditions have been satisfied 1407 (see FIGS. 17-19 for more information). If information is due, an outside vendor user responsible for the information that is due must first provide the information before the facility will allow the invoice to be processed 1408 (see FIG. 20 and the related discussion for details). If all of the required information has been provided at the time of invoice submission, or at any time after the invoice has been submitted, the facility will allow the invoice to be processed 1409.

FIG. 14B is a flow diagram showing examples of the checks the facility conducts with respect to a submitted invoice to determine if information is due or other conditions have not been satisfied, in which case the facility will not allow the invoice to be processed. For example, the facility might check the field or fields that the outside vendor was required to complete regarding information about the matter (such as the law firm matter number, the applicable country for the matter, the applicable state for the matter, etc.) 1451. If the applicable fields have not been completed, the facility will not allow the invoice to be submitted 1450.

In some embodiments, that facility checks when the next status report is due 1452. If the next status report due date is equal to or earlier than today's date then the facility will not allow the invoice to be processed until the status report has been entered into the facility by the outside vendor user (or his or her delegate) responsible for the status report 1450. The content of the status report will be controlled by the facility-level and matter-level settings with respect to the required information described in FIGS. 2A, 2B, and 3.

In some embodiments, the facility checks when the next budget is due 1453. If the next budget due date is equal to or earlier than today's date, then the facility will not allow the invoice to be processed until the budget has been submitted into the facility 1450.

In some embodiments, the facility checks to see if other information has not been completed that has been required by either the company or the operator of the matter management facility 1454. If the information has not been provided, then the facility will not allow the invoice to be processed until the information has been entered in the facility 1450.

In some embodiments the facility checks to see if other condition or conditions have not been satisfied that are required by either the company or the operator of the matter management facility 1455. If the condition or conditions have not been satisfied, then the facility will not allow the invoice to be processed until the condition or conditions have been satisfied 1450.

Depending on the implementation of the facility, the facility may require some or all of checks described in FIG. 14B before the outside vendor can submit an invoice. If all of the required data has been provided and all conditions have been satisfied for processing an invoice, the facility will enable the client to process the invoice 1456.

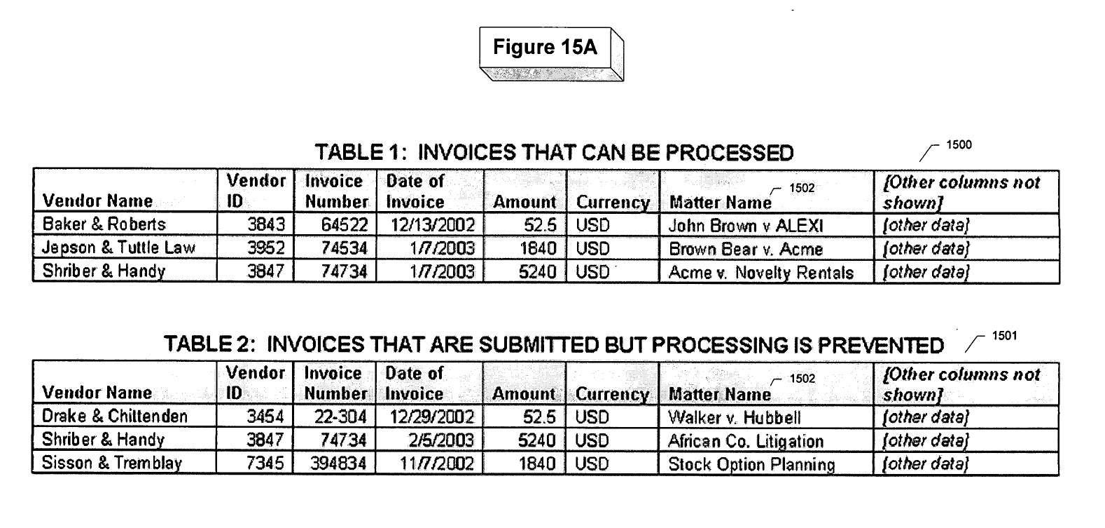

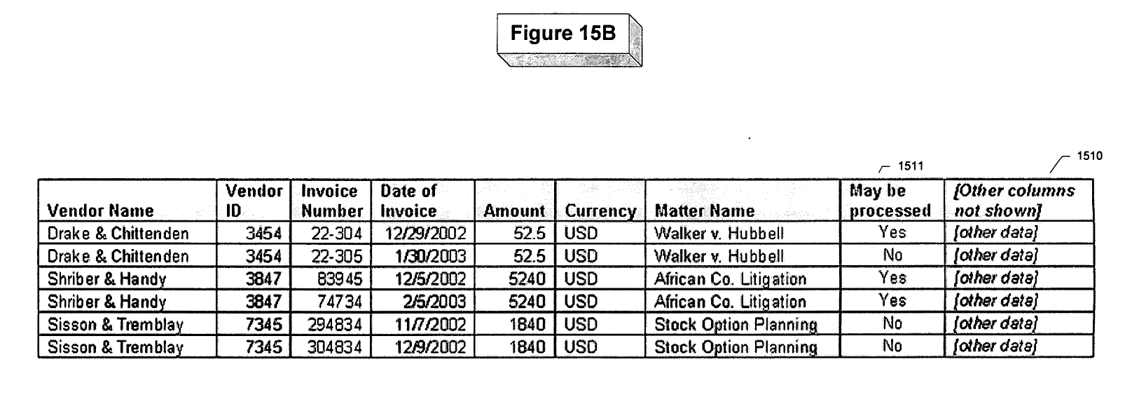

FIG. 15A is a table diagram showing how the facility could distinguish invoices that have been submitted but may not be processed because required information is due by maintaining such invoices in a separate table from the table of invoices that have been submitted and are allowed to be processed. In the diagram, Table 1 1500 is the table in which identifies invoices that have been submitted for which processing can occur (or may have already occurred and the invoice is being approved or may have already been approved). Table 2 1501 identifies those invoices that have been submitted by outside vendors, which will not be processed until the outside vendor provides required information or otherwise satisfies the conditions required with respect to the matter 1502. In some embodiments, Table 2 1501 could include columns that specify the specific categories of the required data that is missing or conditions that have otherwise not been satisfied.

When an invoice is posted as diagramed in FIG. 14A, the facility will save a record of the invoice in Table 1 1500 if the invoice can be processed, but if the invoice is not allowed to be processed, the invoice will be saved in Table 2 1501. If an invoice is submitted that is initially not allowed to be processed, but later the outside vendor satisfies all of the information requirements or other conditions so that the invoice can be processed (as described in FIG. 20), the facility will remove the invoice record from Table 2 1501 and move the invoice record to Table 1 1500.

The advantage of this multi-table structure architecture illustrated in FIG. 14A is that the facility can generate invoicing and spending reports for a company for invoices only in Table 1 1500, which can improve the speed of the report query. Alternatively, if the report criteria allows reports against invoices that have been submitted but may not be processed, then the report query could include invoices from Table 1 1500 and Table 2 1501.

FIG. 15B is an alternate table diagram showing an alternative architecture in which the facility distinguishes invoices that have been submitted but may not be processed from invoices that have been submitted and are allowed to be processed. All invoices are saved in a single table 1510. One of the columns in the table 1511 designates whether the invoice can be processed. In some embodiments, the table 1510 could include columns that specify the nature of the required data that is missing or conditions that have otherwise not been satisfied.

Those skilled in the art will recognize that there may be many ways to segment or mark those invoices that are not to be processed until the required information or conditions have been satisfied.

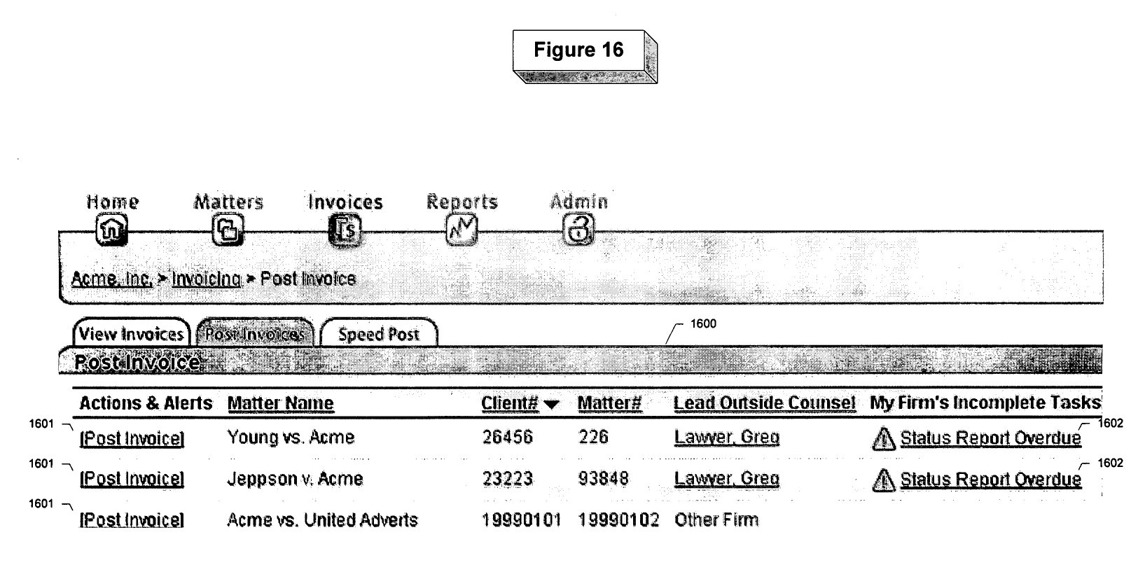

FIG. 16 is a display diagram showing an example of a web page form 1600 used by an outside vendor to submit an invoice. In this particular embodiment, the facility presents a link 1601 that the outside vendor user may click on to submit an invoice. Some embodiments might display the incomplete requirements or tasks that will need to be required before the invoice may be processed (as shown by the incomplete task notice 1602), but this would not prevent the invoice from being submitted.

Those skilled in the art will recognize that there may be many web page formats that can be used for submitting an invoice or groups of invoices. For example, some electronic invoice formats such as LEDES 1998B include a client and matter number in the invoice. Thus, a web page for submitting invoices can be presented to the outside vendor in which the outside vendor does not have to pick a matter, but instead the facility matches the client and matter number in the LEDES 1998B invoice to the corresponding matter in the facility.

FIGS. 17-19 provide examples of various notifications that the facility could provide to the outside vendor that an invoice has been submitted but will not be processed until the required information or other condition has been satisfied. FIG. 17 is a display diagram showing to the Invoice Submitter the invoice submission results and notifications regarding invoices that were successfully submitted but could not be processed because required information is due. In this embodiment, the example shows the results 1700 of multiple invoices being submitted at one time. One section 1701 of the results shows a list of invoices that were successfully posted and the facility will allow the invoice to be processed by the client. Another section 1702 shows a list of invoices that did not post successfully. A third section 1703 shows a list of invoices that were successfully posted, but the facility will not allow to be processed until required information is provided. These results could be displayed immediately after the Invoice Submitter attempted to submit one or more invoices, or could be displayed or retrieved at a later time.

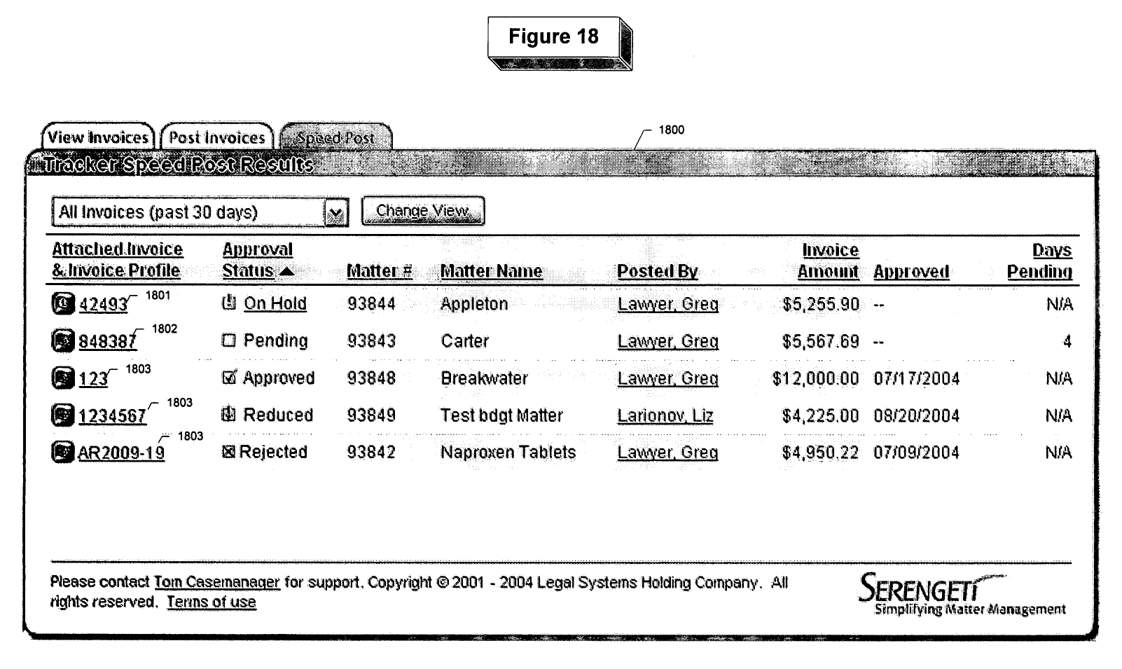

FIG. 18 a display diagram showing the outside vendor invoices that the outside vendor has submitted and the current status of each invoice. In some embodiments, there could be a view of all invoices with activity in the last 30 days 1800. For each invoice, the display might show (i) any invoice that was submitted but cannot be processed because required information is due from the outside vendor 1801; (ii) any invoice that was submitted and the facility will allow to be processed by the client 1802; and (iii) any invoice that was submitted and delivered to the client, and has been processed by the client (examples could include that the invoices was approved, reduced, or rejected by the client) 1803.

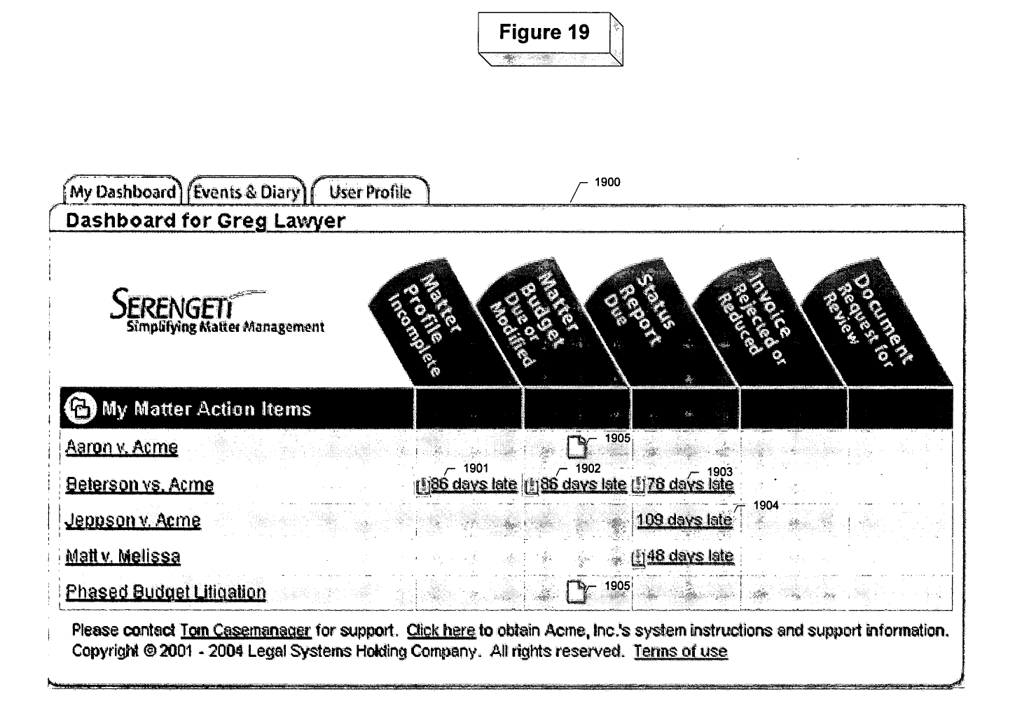

FIG. 19 is a display diagram showing the responsible user of the outside vendor (and his or her delegates) alerts about required information 1900. In this embodiment, the display includes: (1) alerts regarding invoices that have been submitted but the facility will not allow to be processed and (2) what information is due and that must be provided before such a submitted invoice can be processed. For example, the alert could show that information is due for a specific matter, how many days the information has been due, and that an invoice has been posted but cannot be processed because the information is incomplete 1901. Another example is an alert showing that showing that a budget is due for a specific matter, how many days the budget has been due, and that an invoice has been posted but cannot be processed because the information is incomplete 1902. Another example is an alert showing that showing that a status report is due for a specific matter, how many days the status has been due, and that an invoice has been posted but cannot be processed because the information is incomplete 1903. As discussed throughout this application, other embodiments might include alerts of other types of required information. The display might also show separate or different types of alerts of required information for which no invoice has been posted 1903, and other alerts for which information is not required 1904 (e.g., a matter budget has been modified).

Those skilled in the art will recognize that there may be many variations of the foregoing displays in FIGS. 17-19 and many other ways in which the facility could notify the outside vendor that an invoice has been submitted but will not be processed until the required information or other condition has been satisfied. For example, the facility could allow the outside vendor to generate a report to determine which outside vendor user or users are delaying the processing of a submitted invoice because they have not entered required information or satisfied other conditions. Such a report could also include a link or button to send an email notification to one or more of such users who are causing the submitted invoice to not be processed. Other embodiments could send an email to appropriate outside vendor users with a hyperlink in the email, and such hyperlink would direct the user to the appropriate form in the facility that will enable the user to enter the required information or satisfy the condition.

FIG. 20 is a flow diagram showing steps typically performed by the facility to determine whether an invoice may be processed after the outside vendor enters information into the system that may satisfy a currently pending requirement for information or other condition in a matter. When an outside vendor user responsible for data in one or more matters (or his or her delegates) logs into the facility 2001, and enters or updates data in the system (e.g., matter profile data, status report, budget, or other data), or otherwise takes an action in the system that may satisfy a condition 2002, the facility checks the table or list of invoices that have been submitted but are not allowed to be processed (Table 1501 in FIG. 15A, or Table 1510 and column 1511 in FIG. 15B depending on the particular embodiment) and determines if the data or action by the outside vendor satisfies an information requirement or other condition that has prevented one or more invoices from being processed 2003. If the data or action satisfies a requirement for one or more invoices, but if there are other requirements still remaining for any such invoice, then the facility will still not allow such an invoice to be processed, and depending on the embodiment of the facility, (1) the status of the specific condition that is required to be satisfied would be updated (which status could be maintained, depending on the embodiment, in Table 1501 in FIG. 15A or in Table 1510 in FIG. 15B) and (2) the outside vendor is notified that such condition preventing invoice processing has been satisfied, but that the invoice still may not be processed until the remaining conditions have been satisfied 2006. On the other hand, if the data or action satisfies a requirement for any invoice, and there are no other requirements remaining for the invoice, the facility (A) allows the invoice to be processed and sends the applicable notices to responsible company user(s) that the invoice is available for processing 2004; (B) changes the status of the invoice to reflect that it is available for processing (either by moving the invoice from Table 1501 to Table 1500 in FIG. 15A, or by changing the invoice status in column 1511 in FIG. 15B, depending on the embodiment) 2004; and (C) notifies the outside vendor that all of the conditions preventing the invoice from being processed have been satisfied, and that the invoice is now capable of being processed by the company 2005. For example, such notice 2005 could be in the form of an email, or it could be in the form of updates to the displays shown in FIGS. 4 & 18, and in other displays in the facility.

Those skilled in the art will recognize that there may be many ways in which the facility could be designed to track the conditions required for an invoice to be processed, check to see if the conditions have been satisfied when an action is taken in the system or data is entered, update the status of such conditions, and if applicable, release the invoice for processing and notify the applicable users. Also, the release conditions applicable to an invoice could be specific to an individual matter, to a group of matters, or at the facility-level for a system-wide requirement.

It will be understood by those skilled in the art that the above-described facility could be adopted or extended in various ways. For example, the facility may be used to manage information about vendors of vendor types other than law firms, for which kinds of information other than those discussed herein are required. While the foregoing description makes reference to preferred embodiments, the scope of the invention is defined solely by the claims that follow and the elements recited therein.

1. A method in computing system for collecting specified information in conjunction with the submission of an invoice on behalf of a vendor, comprising:
providing a mechanism usable by users associated with the vendor to provide the specified information;
receiving the invoice from a user associated with the vendor;
accepting the received invoice without imposing conditions on such acceptance;
after the invoice has been accepted, determining whether the mechanism has been used by a user associated with the vendor to provide the specified information;
if the mechanism has been used by a user associated with the vendor to provide the specified information, making the received invoice available for payment;
if the mechanism has not been used by a user associated with the vendor to provide the specified information:
providing a notification to at least one user associated with the vendor that identifies specified information that must be provided before the received invoice will be made available for payment; and
making the received invoice available for payment only after the mechanism has been used by a user associated with the vendor to provide the specified information.

2. A method in computing system for collecting specified information in conjunction with the submission of an invoice by a submitter, comprising:
providing a mechanism usable by the submitter to provide the specified information;
receiving the invoice from the submitter; and
after the invoice has been received from the submitter, making the received invoice available for payment only after the mechanism has been used by the submitter to provide the specified information.

3. The method of claim 2 wherein the invoice is received before the mechanism has been used by the submitter to provide the specified information.

4. The method of claim 3, further comprising, in response to receiving the invoice before the mechanism has been used by the submitter to provide the specified information, generating a notification to the submitter that identifies specified information that must be provided before the received invoice will be made available for payment.

5. The method of claim 4 wherein the invoice is received from a first user associated with the submitter, and wherein the notification is generated for a second user associated with the submitter.

6. The method of claim 5 wherein the first user is a billing clerk.

7. The method of claim 5 wherein the second user is an account manager.

8. The method of claim 5 wherein the second user is an attorney.

9. The method of claim 5 wherein the second user is a non-attorney.

10. The method of claim 4 wherein the invoice is received from an automated billing system used by the submitter, and wherein the notification is generated for a human user associated with the submitter.

11. The method of claim 2 wherein the invoice is intended for an invoiced organization,
and wherein making the received invoice available for payment comprises delivering the received invoice to a user belonging to the invoiced organization.

12. The method of claim 2 wherein the invoice is intended for an invoiced organization,
and wherein making the received invoice available for payment comprises displaying the received invoice to a user belonging to the invoiced organization.

13. The method of claim 2 wherein the invoice is intended for an invoiced organization,
and wherein making the received invoice available for payment comprises permitting a user belonging to the invoiced organization to review the received invoice.

14. The method of claim 2 wherein the invoice is intended for an invoiced organization,
and wherein making the received invoice available for payment comprises permitting a user belonging to the invoiced organization to approve the received invoice for payment.

15. The method of claim 2 wherein the invoice is intended for an invoiced organization,
and wherein making the received invoice available for payment comprises permitting the invoiced organization to pay the received invoice.

16. The method of claim 2 wherein the invoice is intended for an invoiced organization,
and wherein making the received invoice available for payment comprises permitting an accounts payable branch of the invoiced organization to pay the received invoice.

17. The method of claim 2 wherein making the received invoice available for payment comprises arranging electronic payment of the received invoice.

18. The method of claim 2 wherein the invoice is intended for an invoiced organization,
and wherein making the received invoice available for payment comprises forwarding the received invoice to an accounts payable branch of the invoiced organization.

19. The method of claim 2 wherein the invoice is received in connection with a distinguished matter being handled by the submitter, and wherein the specified information relates to the distinguished matter.

20. The method of claim 2 wherein the invoice is received in connection with a distinguished on of a plurality of matters being handled by the submitter, and wherein the specified information relates to one or more of a proper superset of the distinguished matters.

21. The method of claim 2 wherein the invoice is received in connection with a distinguished matter being handled by the submitter, and wherein the specified information relates to all work being handled by the submitter.

22. The method of claim 2 wherein the invoice is received in connection with a distinguished matter being handled by the submitter, and wherein the specified information does not relate to the distinguished matter.

23. The method of claim 2 wherein no conditions are imposed on receiving the submitted invoice.

24. The method of claim 2 wherein the only conditions imposed on receiving the submitted invoice relate to the properness of the invoice's contents.

25. The method of claim 2 wherein the only conditions imposed on receiving the submitted invoice relate to the properness of the invoice's formatting.

26. The method of claim 2 wherein the received invoice has a total amount, and wherein the specified information comprises an explanation of why the total amount exceeds an earlier-provided cost estimate.

27. The method of claim 2 wherein the specified information comprises a status report.

28. The method of claim 2 wherein the specified information comprises a budget.

29. The method of claim 2 wherein the specified information comprises an indication of a geographic location to which the invoice relates.

30. The method of claim 2 wherein the invoice relates to a litigation legal matter, and wherein specified information comprises a case analysis and assessment for the litigation legal matter.

31. The method of claim 2 wherein the invoice relates to a litigation legal matter, and wherein specified information comprises an estimate of exposure for the litigation legal matter.

32. The method of claim 2 wherein the specified information comprises confirmation of earlier-provided information.

33. A computer-readable medium whose contents cause a computing system to perform a method for collecting specified information in conjunction with the submission of an invoice by a submitter, the method comprising:
providing a mechanism usable by the submitter to provide the specified information;
receiving the invoice from the submitter; and
after the invoice has been received from the submitter, making the received invoice available for payment only after the mechanism has been used by the submitter to provide the specified information.

34. The computer-readable medium of claim 33 wherein the invoice is intended for an invoiced organization,
and wherein making the received invoice available for payment comprises delivering the received invoice to a user belonging to the invoiced organization.

35. The computer-readable medium of claim 33 wherein the invoice is intended for an invoiced organization,
and wherein making the received invoice available for payment comprises displaying the received invoice to a user belonging to the invoiced organization.

36. The computer-readable medium of claim 33 wherein the invoice is intended for an invoiced organization,
and wherein making the received invoice available for payment comprises permitting a user belonging to the invoiced organization to review the received invoice.

37. The computer-readable medium of claim 33 wherein the invoice is intended for an invoiced organization,
and wherein making the received invoice available for payment comprises permitting a user belonging to the invoiced organization to approve the received invoice for payment.

38. The computer-readable medium of claim 33 wherein the invoice is intended for an invoiced organization,
and wherein making the received invoice available for payment comprises permitting the invoiced organization to pay the received invoice.

39. The computer-readable medium of claim 33 wherein the invoice is intended for an invoiced organization,
and wherein making the received invoice available for payment comprises permitting an accounts payable branch of the invoiced organization to pay the received invoice.

40. The computer-readable medium of claim 33 wherein making the received invoice available for payment comprises arranging electronic payment of the received invoice.

41. The computer-readable medium of claim 33 wherein the invoice is intended for an invoiced organization,
and wherein making the received invoice available for payment comprises forwarding the received invoice to an accounts payable branch of the invoiced organization.

42. A computing system for collecting specified information in conjunction with the submission of an invoice by a submitter, comprising:
a user interface component usable by the submitter to provide the specified information;
an invoice receiving component that receives the invoice from the submitter; and
a payment gating component that, after the invoice has been received from the submitter, makes the received invoice available for payment only after the mechanism has been used by the submitter to provide the specified information.

43. The computing system of claim 42 wherein the invoice is intended for an invoiced organization,
and wherein the payment gating component makes the received invoice available for payment by delivering the received invoice to a user belonging to the invoiced organization.

44. The computing system of claim 42 wherein the invoice is intended for an invoiced organization,
and wherein the payment gating component makes the received invoice available for payment by displaying the received invoice to a user belonging to the invoiced organization.

45. The computing system of claim 42 wherein the invoice is intended for an invoiced organization,
and wherein the payment gating component makes the received invoice available for payment by permitting a user belonging to the invoiced organization to review the received invoice.

46. The computing system of claim 42 wherein the invoice is intended for an invoiced organization,
and wherein the payment gating component makes the received invoice available for payment by permitting a user belonging to the invoiced organization to approve the received invoice for payment.

47. The computing system of claim 42 wherein the invoice is intended for an invoiced organization,
and wherein the payment gating component makes the received invoice available for payment by permitting the invoiced organization to pay the received invoice.

48. The computing system of claim 42 wherein the invoice is intended for an invoiced organization,
and wherein the payment gating component makes the received invoice available for payment by permitting an accounts payable branch of the invoiced organization to pay the received invoice.

49. The computing system of claim 42 wherein the payment gating component makes the received invoice available for payment by arranging electronic payment of the received invoice.

50. The computing system of claim 42 wherein the invoice is intended for an invoiced organization,
and wherein the payment gating component makes the received invoice available for payment by forwarding the received invoice to an accounts payable branch of the invoiced organization.

51. One or more generated data signals collectively conveying to a user associated with a vendor that has submitted an invoice a notification data structure relating to the submitted invoice, the notification data structure comprising:
information identifying one or more required information items; and
information indicating that the submitted invoice will only be made available for processing after the identified required information items are provided by the vendor.
